(19) United States
(12) Patent Application Publication
(10) Pub. No.: US 2009/0109984 A1
(43) Pub. Date: Apr. 30, 2009

(54) WIRELESS DEVICE WITH FLASH CACHE AND BOOT FROM DOCK

(75) Inventors: Gary D. Huber, Austin, TX (US); Yuan-Chang Lo, Austin, TX (US); Roy Stedman, Austin, TX (US); Seth Feder, Austin, TX (US)

Correspondence Address: HAYNES AND BOONE, LLP;IP Section, 2323 Victory Avenue, Suite 700, Dallas, TX, 75219, US

(73) Assignee: Dell Products L.P., Round Rock, TX (US)

(21) Appl. No.: 11/931,505

(22) Filed: Oct. 31, 2007

(51) Int. Cl. H04L 12/56

(52) U.S. Cl. 370/401

(57) ABSTRACT

A device is docked to a docking station. The docking station is coupled to a wired network. Code is obtained through the wired network. The code is executed on the device to enable the device to couple to a wireless network.

### BACKGROUND

The present disclosure relates generally to information handling systems, and more particularly to wireless devices and docking stations.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, health care industry processing, enterprise data storage, or global communications. In addition, IHSs may include a variety of hardware and software components that may be configured to process, store, and communicate information and may include one or more computer systems, data storage systems, and networking systems. The networking systems may be wired networking systems and/or wireless networking systems.

Conventionally, wireless devices include hard disk drives. This can result in the wireless devices having poor battery life and being heavy to carry around. Traditionally, some users mount the wireless devices on mobile carts in order to recharge the batteries and to alleviate the weight issue. The mobile carts are unwieldy, expensive, take up valuable space, and cannot be shared.

Accordingly, it would be desirable to provide an improved wireless device providing advantages over the conventional devices.

### SUMMARY

According to one embodiment, a device is docked to a docking station that is coupled to a wired network. Code is obtained through the wired network and executed on the device to enable the device to couple to a wireless network.

### BRIEF DESCRIPTION OF THE DRAWINGS

FIG. 1 illustrates an embodiment of an information handling system.

FIG. 2 depicts an embodiment of a front view of a wireless device and a docking station.

FIG. 3 shows an embodiment of a method to use a wireless device.

FIG. 4 illustrates an embodiment of a wireless device architecture.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

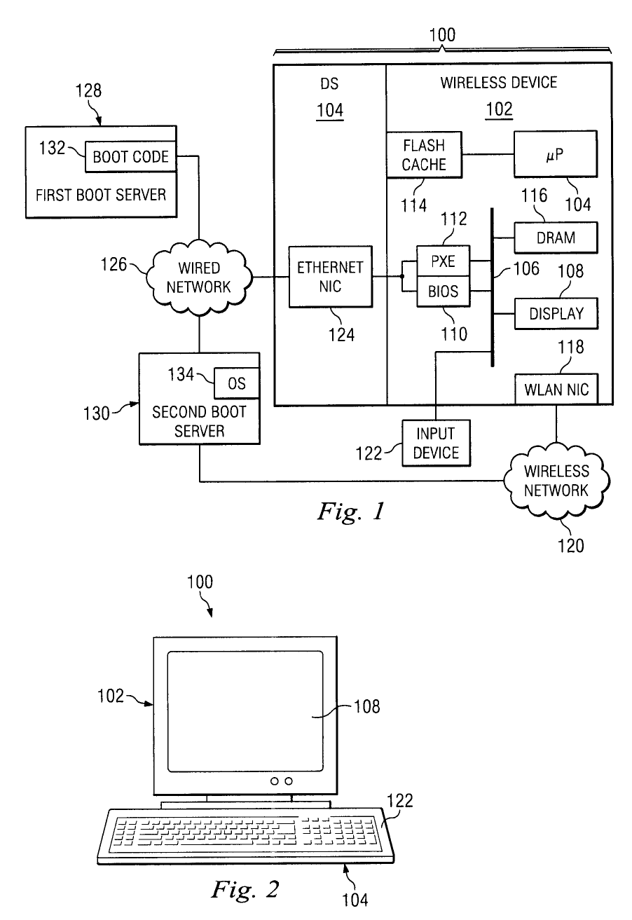

Referring now to FIG. 1, in one embodiment, an IHS 100 includes a wireless device 102 docked to a docking station 104. The wireless device 102 includes a processor 104, which is connected to a bus 106. The processor 104 executes instructions. The bus 106 serves as a connection between the processor 104 and other components of the wireless device 102. The wireless device 102 further includes a display 108. Examples of displays include cathode ray tube displays, liquid crystal displays, digital light processing displays, plasma displays, organic light-emitting diode displays, electroluminescent displays, surface-conduction electron emitter displays, field emission displays, and nano-emissive displays. The wireless device 102 further includes Basic Input/Output System (BIOS) code 110 and Pre-boot Execution Environment (PXE) code 112. The BIOS code 110 may include instructions that are executed by the processor 104 to perform basic initialization of the IHS 100. The PXE code 112 may include instructions that are executed by the processor 104 to access remote boot code on a network. In an embodiment, the BIOS code 110 and the PXE code 112 are stored on flash memory. The wireless device 102 further includes a flash cache 114 and a Dynamic Random Access Memory (DRAM) 116. The flash cache 114 may be used to store instructions and data persistently across power cycles of the IHS 100. The DRAM 116 may be used to store instructions and data temporarily (i.e., not persistently across power cycles of the IHS 100). The wireless device 102 further includes a Wireless Local Area Network (WLAN) Network Interface Card (NIC) 118. The WLAN NIC 118 may be configured to be wirelessly coupled to a wireless network 120 and may be used by the IHS 100 to communicate through the wireless network 120 with other IHSs. In an embodiment, the wireless network 120 may include a WLAN.

The docking station 104 includes an input device 122 that is coupled to the processor 104 to provide input to the processor 104. Examples of input devices include keyboards, touchscreens, and pointing devices such as mouses, trackballs and trackpads. The docking station 104 further includes an Ethernet Network Interface Card (NIC) 124. The Ethernet NIC 124 may be coupled to a wired network 126 and may be used by the IHS 100 to communicate through the wired network 126 to communicate with other IHSs, such as a first boot server 128 and a second boot server 130. In an embodiment, the wired network 126 may include an Ethernet network. In an embodiment, the wired network 126 and the wireless network 120 may be coupled such that IHSs coupled to the wired network 126 may be able to communicate with other IHSs coupled to the wireless network 120.

The first boot server 128 and the second boot server 130 may be coupled to the wired network 126 and may provide instructions and data to the IHS 100 through the wired network 126. The second boot server may further be coupled to the wireless network 120 and may provide instructions and data to the IHS 100 through the wireless network 120. In an embodiment, the first boot server 128 and the second boot server 130 may be a single server that includes the same functionalities of the first boot server 128 and the second boot server 130.

The first boot server 128 includes boot code 132. The PXE code 112 may be executed by the processor 104 of the wireless device 102 to use the Ethernet NIC 124 of the docking station 104 and the wired network 126 to obtain the boot code 132 from the first boot server 128 and store the boot code 132 in the DRAM 116. In an embodiment, the processor 104 may further store some or all of the boot code 132 in the flash cache 114. The processor 104 may then execute the boot code 132. The boot code 132 may include instructions to initialize the components of the IHS 100 and to load an operating system (OS). The boot code 132 may be executed by the processor 104 of the wireless device 102 to access an OS file system 134, which is included in the second boot server 130. In an embodiment, the processor may store some or all of the contents of the OS file system 134 in the flash cache 114. The OS file system 134 may include OS code such as, for example, device drivers, applications, configuration files, documents, wireless access information, and wireless security information.

It should be understood that other buses and intermediate circuits can be deployed between the components described above and processor 104 to facilitate interconnection between the components and the processor 104.

Referring now to FIG. 2, a front view of the wireless device 102 docked to the docking station 104 is depicted. The wireless device 102 includes the display 108. The wireless device 102 may include a diskless tablet personal computer or a diskless slate device. The docking station 104 includes the input device 122. When the wireless device 102 is docked to the docking station 104, the combination of the wireless device 102 and the docking station 104 may appear to a user to be similar to a laptop computer and the user may use the input device 122 of the docking station 104 to interact with the wireless device 102. Although the input device 122 is illustrated as a keyboard, the wireless device may include any single input device or any combination of input devices. The docking station 104 may be coupled to a wall, desktop, or articulating arm. When the user desires mobility, the user may undock the wireless device 102 from the docking station 104 and relocate the wireless device 102. While undocked, the wireless device 102 may continue to function as an IHS, and may continue to use the WLAN NIC 118 to communicate through the wireless network 120. In an embodiment, the wireless device 102 may then be re-docked to another docking station. In an embodiment, the wireless device 102 may be configured to not allow the wireless device 102 to be docked to the another docking station. In an embodiment, the docking station 104 may be a hub for connecting additional devices to the wireless device 102 such as, for example, a blood pressure device, a mouse, a keyboard, a temperature probe, and/or a variety of other devices known in the art.

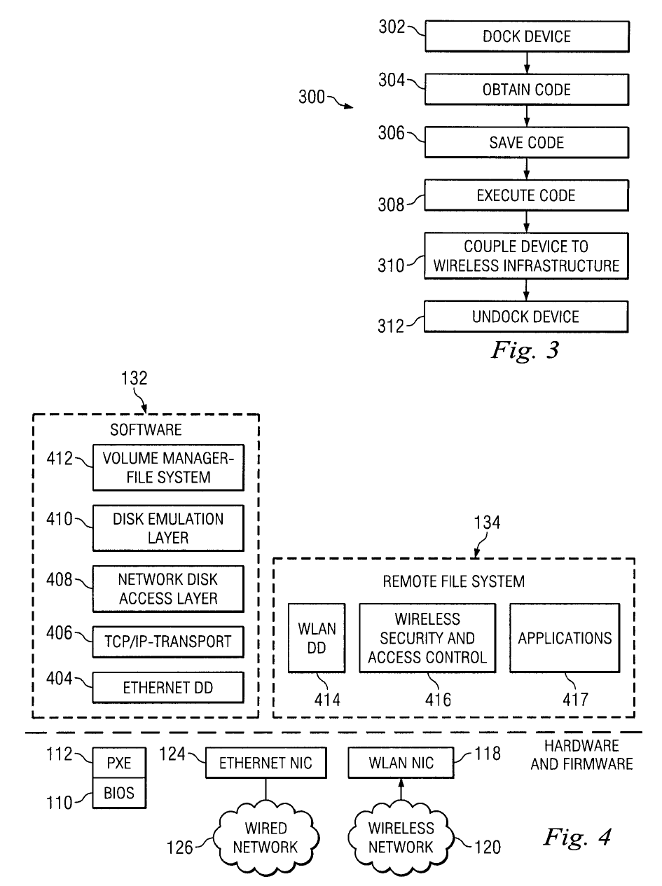

Referring now to FIGS. 3 and 4, a method 300 to use the wireless device 102 is illustrated. The method 300 begins at step 302 where the docking station 104 is coupled to the wired network 126 through the Ethernet NIC 124 and the wireless device 102 is docked to the docking station 104. In an embodiment, the wireless device 102 is powered on and the BIOS code 110 is executed by the processor 104 of the wireless device 102 to initialize the wireless device 102. The PXE code 112 is then executed by the processor 104 of the wireless device 102 to obtain the boot code 132 from the first boot server 128 through the wired network 126. In an alternative embodiment, the boot code 132 may be stored in flash memory of the wireless device 102. The boot code 132 includes an Ethernet Device Driver 404, a TCP/IP Transport 406, a Network Disk Access Layer 408, a Disk Emulation Layer 410, and a Volume Manager—File System 412. The processor 104 of the wireless device 102 saves the boot code 132 in the DRAM 116 of the wireless device 102. The Ethernet Device Driver 404, the TCP/IP Transport 406, the Network Disk Access Layer 408, the Disk Emulation Layer 410, and the Volume Manager—File System 412 may be used by the wireless device 102 to emulate a hard disk drive that contains the OS file system 134. For example, to software on the wireless device 102, the OS file system 134 may appear to be on a local hard disk drive. The OS file system 134 includes wireless code, which includes a WLAN Device Driver 414 and a Wireless Security & Access Control module 416. The wireless code may include a variety of instructions and data for enabling the wireless device 102 to couple to the wireless network 120. The OS file system 134 further includes applications 417, which may be used by the wireless device 102 to enable other functions of the OS.

The method 300 then continues to step 304 where the wireless code is obtained from the OS file system 134 through the wired network 126. The processor 104 uses the boot code 132 from the first boot server 128 to connect to the second boot server 130, access the OS file system 134 of the second boot server 130, and obtain the wireless code from the OS file system 134. The wireless code may then be stored in the DRAM 116 of the wireless device 102.

The method 300 then continues to step 306 where the wireless code is saved in the flash cache 114 of the wireless device 102. In an embodiment, only portions of the wireless code may be stored in the flash cache 114. In an embodiment, other contents of the OS file system, such as the applications 417, may be further stored in the flash cache 114.

The method 300 then continues to step 308 where the wireless code is executed on the wireless device 102 to enable the wireless device 102 to couple to the wireless network 120. In an embodiment, enabling the wireless device 102 to couple to the wireless network 120 includes supporting an authentication protocol and using the authentication protocol to provide information. In an embodiment, the information may include a password, an embedded certificate, and/or a token device.

The method 300 then continues to step 310 where the wireless device 102 is coupled to the wireless network 120. The method 300 then continues to step 312 where the wireless device 102 is undocked from the docking station 104. While undocked from the docking station, the wireless device 102 continues to have access to the wireless network 120. In an embodiment, the docking station 104 includes a wireless access point (WAP) which implements the wireless network 120, such that the wireless device 102 being coupled to the wireless network includes the wireless device 102 being coupled to the WAP. In an embodiment, the wireless device 102 may have a roaming capability such that, when the wireless device 102 is moved out of the range of the WAP of the docking station 104, the wireless device may connect to a WAP of another docking station. In an embodiment, an invisible tether is provided from the wireless device 102 to the WAP of the docking station 104 such that the roaming capability of the wireless device 102 is not enabled and the wireless device 102 is not enabled to connect to a WAP of another docking station. In an embodiment, the wireless device 102 may be rebooted using code (i.e., some or all of the boot code 132 and/or the OS file system 134) previously stored in the flash cache 114 without needing to be re-docked to the docking station 104. In an alternative embodiment, the wireless device 102 may require re-docking to the docking station 104 in order to be rebooted.

Thus, embodiments are provided that allow a wireless device without hard disk storage to access a wireless network. While docked to a docking station, the wireless device may be booted up to a point where it has gained access to the wireless network. The wireless device may then maintain the wireless network access after it has been removed from the docking station.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A method comprising:
docking a device to a docking station, wherein the docking station is coupled to a wired network;
obtaining code through the wired network; and
executing the code on the device to enable the device to couple to a wireless network.

2. The method of claim 1, further comprising:
coupling the device to the wireless network.

3. The method of claim 2, further comprising:
undocking the device.

4. The method of claim 1, further comprising:
saving the code on the device.

5. The method of claim 1, wherein enabling the device to couple to the wireless network includes:
supporting an authentication protocol; and
using the authentication protocol to provide information.

6. The method of claim 5, wherein the information is selected from the group consisting of a password, an embedded certificate, a token device, and combinations thereof.

7. The method of claim 1, wherein the code includes at least one selected from the group consisting of operating system code, firmware code, BIOS, and combinations thereof.

8. The method of claim 1, wherein the wired network includes an Ethernet network and the wireless network includes a wireless Local Area Network (LAN).

9. The method of claim 1, wherein the device is one of a personal computer tablet device and a slate device.

10. The method of claim 1, further comprising:
providing an invisible tether for the device.

11. The method of claim 10, wherein providing the invisible tether for the device includes disabling a roaming capability of the device.

12. A docking station comprising:
a wired interface to couple a device to a wired network; and
a wireless interface to couple the device to a wireless network.

13. The docking station of claim 12, wherein the wired interface is used to couple the device to a remote server using the wired network, and wherein the remote server includes code that can be downloaded through the wired network and executed by the device to enable the device to couple to the wireless network.

14. The docking station of claim 12, further comprising:
an invisible tether to the device.

15. The docking station of claim 12, further comprising:
an input device.

16. The docking station of claim 15, wherein the input device includes a keyboard.

17. The docking station of claim 12, further comprising:
a hub for further devices.

18. The docking station of claim 17, wherein the wireless interface includes a wireless access point.

19. An information handling system comprising:
a flash cache including computer-readable instructions for a device to use a wireless network; and
a processor, wherein the processor executes the computer-readable instructions.

20. The information handling system of claim 19, further comprising:
computer-readable instructions selected from the group consisting of code required to bootstrap the information handling system, low-level device drivers, device drivers for the wireless network, software, operating system, and combinations thereof.
